(19) United States
(12) Patent Application Publication
(10) Pub. No.: US 2008/0292092 A1
(43) Pub. Date: Nov. 27, 2008

(54) SYSTEM AND METHOD FOR TELEPHONE NUMBER NORMALIZATION AND DENORMALIZATION

(76) Inventors: Jeff A. LaPorte, Vancouver (CA); Colin Shong Chin Quon, Vancouver (CA); Eric Donald Unrau, Vancouver (CA)

Correspondence Address: KNOBBE MARTENS OLSON & BEAR LLP, 2040 MAIN STREET, FOURTEENTH FLOOR, IRVINE, CA, 92614, US

(21) Appl. No.: 11/752,116

(22) Filed: May 22, 2007

(51) Int. Cl. H04M 1/00

(52) U.S. Cl. 379/355.08

(57) ABSTRACT

A method is disclosed that normalizes a telephone number from a number of input sources into standardized E.164 “+” format so that the telephone number can be represented in a consistent format relative to the user's own mobile number MSISDN and used uniformly across different functional components in a communications system. The disclosure also describes a method for denormalizing a telephone number in the E.164 “+” format into a dial digit phone number sequence that can be used to successfully establish calls from a user terminal device and to route calls via optimal routes through a voice termination network.

### BACKGROUND

1. Technical Field

This disclosure relates to the field of communications processing. More specifically the disclosure relates to the processing functions performed for dynamic and least cost routing for mobile originated calls.

2. Description of the Related Art

Canada has a relatively unique mobile tariff structure where mobile roaming within Canada is free and local service area calling is included in monthly packages but calling outside of a local service region initiates long distance rates. If a mobile caller in Canada calls a phone number outside of Canada or outside of the user's mobile home service region, it is generally cheaper to use an alternate international calling service provider, whereas if the caller calls a number in the same service region, it is generally cheaper to call directly from the mobile phone without an alternate service provider. If the caller roams into a different service region, it is generally less expensive to use an alternate service provider to connect the voice call back to their home service region.

The United States of America also has a relatively unique mobile tariff structure where roaming within the U.S. is typically included in monthly packages, and the cost of calling anywhere within the U.S. is also included in the monthly packages. In the U.S., most mobile service plans offer a single rate for all calls within the entire country independent of service region or geographical distance. As a result, it is generally less expensive for a mobile caller to call directly from the mobile phone to a phone number within the U.S. instead of calling through an alternate calling service provider. On the other hand, mobile originated calls for users without bundled international calling service plans to destinations outside the U.S. are generally less expensive through an alternate service provider.

Mobile originated least cost optimization also requires different considerations in Europe and Asia. For example, in the United Kingdom, where the calling party pays, mobile originated calls to most landlines and national-local numbers typically have a single rate, whereas mobile originated calls between different mobile service providers carry different and generally more expensive tariff rates. In addition, in many of these countries, the mobile originated calling cost also depends on the time of the day and the day of the week. This time-of-day cost is different from free weekends and evenings typical of many mobile carrier service plans.

For a service that attempts to optimize call origination least cost, one of the key design considerations is the need for call number translation logic that categorizes the NPA-NXX (Numbering Plan Area-Numbering Plan Exchange) number ranges within the North American country code that is shared by Canada, the United States, and some of the Caribbean Islands. For countries such as the UK, where there are time-of-day cost variations, and mobile-to-mobile calling may be more expensive than mobile-to-landline and then bridged from landline to mobile, different mobile origination flows are required to optimize call origination for least cost routing.

A number of service providers, including Cellity, are offering mobile clients with country specific least cost routing rules for mobile originated calls. With the Cellity service, every call a customer makes is verified to establish whether it is abroad or not. If it is a national call, it is routed via the user's mobile service provider. If it is a call abroad, it is automatically routed via Cellity. The actual price for a call abroad is calculated by the connection fee to Cellity (the cost of a landline call) plus the connection fee to terminate the call. The limitation of this approach is that it does not take into consideration factors such as regulatory and differences in tariff structures, user specific service packages, and time of day and call destination routing, such as 800 number services.

### SUMMARY

In an embodiment of the present disclosure, a caller with a mobile phone connects to a local access line, then the service gateway connects the incoming call to the access line that matches the caller CLID to establish the first call leg, and then initiates a call to the callee party as a second call leg, and pins the two call legs together for an end-to-end voice path between the caller and callee. In order to link a call from mobile to a landline trunk and reroute it to another mobile or destination number, the calling digits generally need to be normalized from the mobile handset and potentially renormalized again at the landline access trunk, and then denormalized to bridge the call to the destination number. For example, a user with mobile phone in Vancouver, Canada can dial “+16042738173”, “16042738173”, or “6042738173” which are all valid digit variants of the same callee party number. When the mobile phone with CLID connects to a local dial-in access line and is then subsequently trunked to a core network VoIP service, the format of the CLID may be altered to any of the valid digit variants or origination carrier which may provide the CLID in a specific digit format. If the VoIP bridging service then bridges the call to the destination callee number, the VoIP service needs to dial the callee party number in the correct digit format. Hence, the callee party digits from the caller mobile phone as well as the caller CLID presented to the access line trunk need to be normalized, and the callee number needs to be denormalized before being presented to the terminating voice trunk. This disclosure provides methods to normalize as well as denormalize telephone numbers within a system to allow voice service bridging for a variety of call flows.

An embodiment of the present disclosure may be found in EQO Mobile, a mobile phone service from EQO, the assignee of the present disclosure, that enables users to make global calls at some of the lowest international rates available, send global text messages, and chat using all the major Instant Messaging clients such as MSN Messenger, GoogleTalk, Yahoo, AIM, and ICQ. EQO will be discussed as a service including representative embodiments of the present disclosure, but it is important to note that the present disclosure may be implemented in various other systems. EQO provides a free downloadable mobile software application that is easy to install, and as simple to use as a standard phone address book. The EQO-to-EQO voice calling service allows voice calls between any EQO users as local dial access calls or free VoIP calls. The EQO Out voice calling service allows EQO users to call any phone number through local access to the EQO service from mass market mobile phones. The EQO service also supports EQO-to-EQO multimedia messaging, EQO Out text messaging, and premium services such as click-to-conference, dynamic call disposition such as redirect to alternate number or voice mail, directory services, etc.

In one embodiment, the EQO service allows the EQO user to import contacts from the user's existing mobile phone book. The phone numbers of these contacts may be stored in various formats that are routable in different service provider networks. One aspect of a feature as described in this disclosure is the canonical normalization of contact telephone numbers in different calling digit pattern formats into the E.164 format with “+”. Similarly, when an EQO user calls into an EQO service access line, the user mobile MSISDN (Mobile Systems International Subscriber Identity Number) is presented to the access line and trunked through the call origination interconnect vendor to the EQO service network preferably as, but not limited to, a SIP (Session Initiation Protocol) INVITE message. The “From” header of this call initiation message may have vendor specific calling digit pattern formats. An embodiment normalizes these number patterns such that all network components operate on digits in canonical normalized form. A variant of this normalization also applies to ad-hoc calling digit strings. The normalization can also be conditional to the user's own MSISDN and calling service area.

For EQO Out calls, the service first establishes the originating call leg between the callers preferably through, but not limited to, a forward dial flow connecting through a dial access line to the service (there can be variants of this call flow such as a call back). The service then establishes a terminating call leg from the service through a call termination interconnect vendor to the callee party. Another element of an embodiment of the service is the denormalization of the callee party calling digit patterns so that it can be successfully routed through the interconnect partner network. In addition, an aspect of the present disclosure includes an optional denormalization of the caller party MSISDN such that the “From” CLID can be presented to the interconnect network so that the callee party sees the calling party ID to come from the originating caller rather than from the service. Another embodiment of this inventive design includes establishing the originating call leg through a call-back flow using the same calling digit denormalization process.

Another aspect of the present disclosure service is the enhancement processing applied for dynamic and least cost routing for mobile originated calls. This enhanced processing takes into consideration the processing, battery, bandwidth cost, and user interface constraints of mobile devices, local regulatory and market conditions, as well as the usability requirements required for a real-time calling user experience. The mobile originating least cost processing can also be conditional to the user services plan with the user's mobile carrier, the serving location, the mobile calling service area, and the called destination. For a user with an MSISDN NPA-NXX that falls inside Canada, one preferred mobile originating least cost method is to route the international calling via the EQO application but prompt the user with the option to select direct calling through the mobile operator or via the EQO Out service for calls within Canada. For a user with MSISDN NPA-NXX that falls within USA, one preferred mobile originating least cost method is to always route calls within USA directly to the mobile operator, and to route international calls through the EQO Out service.

Countries outside of the North American Dial Plan all have unique country prefixes. In most of these other countries, when the user's MSISDN country prefix matches the called number country prefix, one preferred mobile originating least cost method is to route the call directly from the phone, and any other calls through the EQO Out service. However, this enhancement processing logic can take into consideration the time of day, as well as the call destination. For example, if the call destination is another mobile number, the EQO calling service can prompt the user to select the preferred calling method for least cost call origination, or the enhancement processing be automated through a set of user preferences and call handling rules. The enhancement processing logic can also be conditional on a handset device, such as a dual-mode phone, the available transport network such as WiFi, WiMax, and 3G wireless, the caller location, and the caller's preference.

Neither this summary nor the following detailed description purports to limit the invention. Rather, the invention is defined by the appended claims.

### BRIEF DESCRIPTION OF THE DRAWINGS

FIG. 1 is an embodiment of the present system showing a mobile client, a core network, and the interconnect networks that allow the delivery of voice calls.

FIG. 2 shows one embodiment of a telephone number digit normalization and denormalization system context.

### DETAILED DESCRIPTION OF SPECIFIC EMBODIMENTS

The following description is intended to illustrate embodiments and features of the present disclosure, and is not intended to limit the scope.

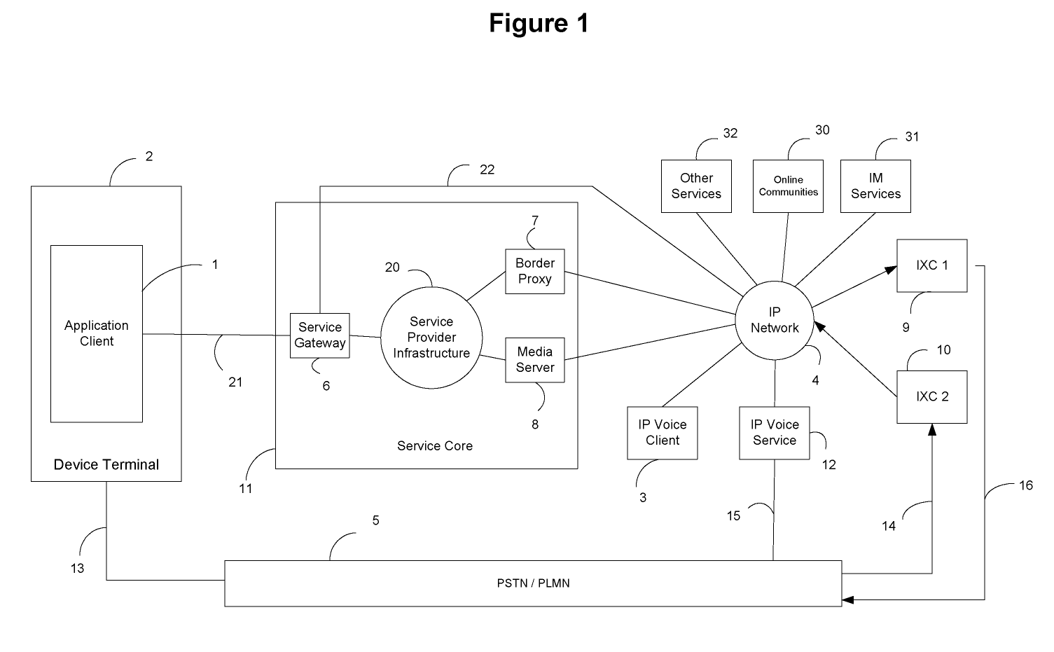

An embodiment of the disclosed system and services is depicted by the system as illustrated in FIG. 1. As shown in FIG. 1, the system consists of an application client 1 hosted on one or more of any of a variety of device terminals 2 that is preferably a mobile device with an open application environment such as J2ME, Blackberry, Symbian, and WindowsMobile. The device terminal 2 preferably is capable of voice services through network interface 13 and data services through network interface 21 on service networks such as GSM/GPRS/EDGE, UMTS, CDMA, WiFi, and WiMAX. The application client 1 is preferably the same as the mobile client described in application Ser. No. 11/428,283, filed on Jun. 30, 2006, the disclosure of which is hereby incorporated by reference.

The application client 1 comprises a signaling interface to the service gateway 6 in the service core 11 via an interface 21 that is preferably, but not limited to, an IP transport network. The application client 1 may include a media interface such as support for voice services via the device terminal 2 through the service network interface 13. In another embodiment, the application client 1 and the VoIP media client 3 can be on the same device terminal 2. The application client 1 preferably provides a user interface which may display a contact list, message, instant messaging, and events such as call requests, presence status, messaging, and/or contact synchronization based on the digital signals received over the interface 21. The application client 1 preferably also may transmit client and user event information over interface 21 to the service gateway 6. In an embodiment, the application client 1 hosted on the device terminal 2 has access to the voice and data services on the device terminal 2 through its internal device application programming interfaces (APIs).

The service core 11 preferably includes the service gateway 6, the service provider infrastructure 20, signaling border proxy 7, and media server 8. The service gateway 6 is preferably the same as, or similar to, the service gateway described in application Ser. No. 11/428,283, filed on Jun. 30, 2006, the disclosure of which is hereby incorporated by reference. The service core 11, as well as associated components, such as service gateway 6, signaling border proxy 7 and media server 8, may be implemented on a single computing device or multiple connected computing devices. Such connections may be accomplished through any of a number of techniques, such as through busing, local or wide area networks, wired or wireless systems, and the like. The computing devices may be single- or multi-processor devices and processors may be single- or multi-core general or specialized processors. The service gateway 6 is an application server that provides signaling control and service bridging functions between the application client 1 via device terminal 2 and external service networks such as the PSTN 5 and an IP voice service network 12, such as GoogleTalk or Vonage. The service gateway 6 preferably also provides other service bridging functions via interface 22 to one or more IM services networks 31, such as MSN, Yahoo, AIM, and QQ, one or more online communities 30, such as Myspace and Facebook, and/or other services 32 such as Skype and Short Messaging Service (SMS) interconnect. Interface 22 may be implemented as service proxies or plug-in clients as in the case of Skype and are preferably implemented over an IP transport network.

In an embodiment, the service provider infrastructure 20 in the service core 11 provides various service functions, such as a subscriber service database, a contact list and presence server, accounting and billing mediation, prepaid servers, service payment web services, SIP registrar and redirect servers, web servers for service fulfillment and/or user provisioning, and network management, as well as other operational and business support systems.

For voice service, at the signaling layer, the service gateway 6 and service provider infrastructure 20 interfaces to the public switched telephone network (PSTN) through the signaling border proxy 7 that preferably uses SIP as the signaling protocol. The border proxy 7 may interface with a number of voice origination providers 10, and a number of voice termination providers 9 through network 4. The border proxy 7 may also interface with IP voice services 12 and IP voice clients 3 through network 4. At the media layer, in an embodiment, the media server 8 bridges one or multi-party voice media from voice origination network 10 and voice termination network 9, as well as IP voice services network 12 and IP voice clients 3. In various embodiments, the media server may not always be required and may be used primarily during certain phases of the call setup, such as with respect to tones, announcements, conferencing, and/or voicemail. Preferably, the media server interfaces with voice origination network 10, voice termination network 9, IP voice service network 12 and IP voice client 3 using Real Time Protocol (RTP).

### Mobile Originated Least Cost Routing

In an embodiment, mobile originated least cost routing in the disclosed system involves enhancement processing in the service gateway 6 and in the mobile application client 1. In an embodiment, upon mobile application client 1 registration, the following processing can be executed on the service gateway 6:

Parse country code (CC) of user normalized MSISDN in subscriber record

If CC==“1”, then parse NPA from normalized MSISDN in subscriber record

send CONFIGURATION message setting CC value on mobile
If CC=1
send CONFIGURATION message setting NPA

Where the mobile application client 1 enhancement processing determines the need to place a call through the service rather than initiating a call directly from the device terminal 2 to the callee destination 5, 12, the service gateway 6 can execute the following processing:
Based on any NPA prefix pattern of the user MSISDN and/or conditional on user state such as device type, time of day, network connectivity such as WiFi access, or calling preferences, select an access trunk or access method
Map the access trunk to an access number and provide the dial access number to the mobile client, or map the access method to a service resource such as SIP user agent and send the call session initiation to the mobile client

The mobile client 1 that is preferably a mobile application client can perform a set of processing steps to determine the least cost routing for originating calls from the device terminal 2 or the service client 3 either through the core network 11 or directly from the terminal 2, 3 to the destination service 5, 12.
Mobile Client determines whether user MSISDN is in the home dialing area or least cost serving area via the service gateway during the REGISTRATION
Mobile Client stores the CC and NPA if applicable of the user's MSISDN. These values may be updated to the Mobile Client from the service gateway as necessary.

The mobile client 1 then executes a decision process for determining if pre-normalized DN is inside or outside the home dialing area. A different variant set of steps would apply for decision processing that is conditioned on device type, such as dual-mode phone, access network, such as WiFi or 3G data, time of day, geographical location, user preference, etc. The following shows one sample variant for determining least cost routing for calls within Canada and for those from Canada to another country, and similarly for Caribbean islands, USA, and rest of the world:
//Where CC=country code, NPAdn=NPA dialed number, NPAuser=NPA of the service user
Truncate leading “+” from dialed number
Attempt match of user's CC to leading 1, 2, 3, or 4 digits depending on CC length.
If entire CC matches and is “1”
   If NPAdn is in Canadian NPA list && NPAuser is in Canadian NPA list
      then popup prompt to ask
      else do service dial
   If NPAdn is (in Canadian NPA list∥in Caribbean list) && NPAuser is not (in Canadian NPA list∥in Caribbean list)//USA
      then do service dial
      else do direct dial
If entire CC matches//Rest of World
   then dial call as direct dial from user device to callee party
   else dial call via dial access to Service access gateway to bridge to callee party

The specific example shown above allows the least cost handling logic to be compact for resource constrained handsets. In the above, the total list of North America NPA can be compacted by only specifying the current 25. Canadian NPAs and the 22 Caribbean NPA (total of 388 bytes assuming 4 characters per NPA).

### Telephone Digit Normalization and Denormalization

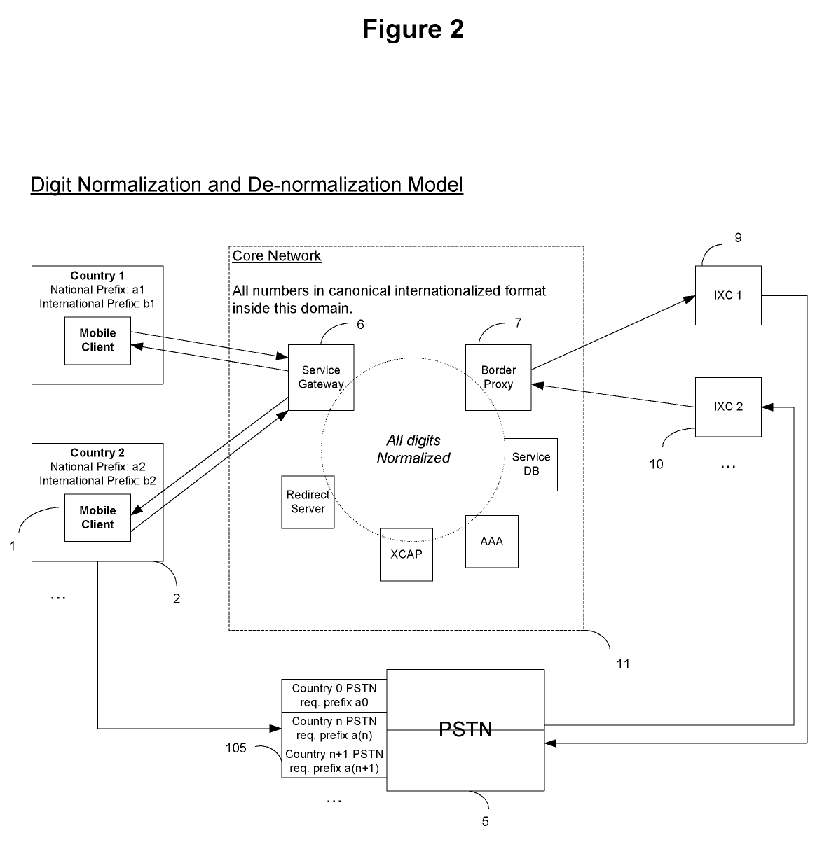

An embodiment of the telephone digit normalization and denormalization for the disclosed system, as may be embodied by EQO, supporting telephone number based voice calling is shown in FIG. 2. In an embodiment, telephone digit normalization may be required for contacts imported from a device terminal 2 into a system mobile client 1 which is then normalized by the service gateway 6 in the core network 11 and synchronized back to the mobile client 1 in canonically normalized E.164 numbering format with the “+” prefix. Any ad hoc calling digits entered by the user from the mobile client 1 would also be normalized by the service gateway 6. For call legs arriving from a voice interconnect network 10 to the border proxy 7, the “From” caller ID digit may also need to be normalized as different interconnect providers may have different digit formats.

For calls connecting to a service as discussed herein, the service gateway 6 denormalizes the calling access number and provides the access number to the client 1, which then initiates the call. This initiation may occur through a J2ME platform request through the device terminal 2 to an access number 105 that is then truncated by the call origination interconnect provider 10 to the core network. If the mobile client 1 and service gateway 6 determine that a least cost should be routed directly from the device terminal 2 directly to the callee destination in the PSTN 5 rather than through the service, the service gateway 6 also similarly provides the denormalized callee telephone digits so that a call can be successfully initiated such as through a J2ME platform request through the device terminal 2 to the callee destination in the PSTN 5. For call legs that terminate at a callee destination in the PSTN 5 external to the core network 11, the system also denormalizes the “To” telephone digits from the border proxy 7 to call termination interconnect provider 9.

The following is one embodiment of a set of implementation logics within the service gateway 6 for normalization and denormalization of telephone digits. This implementation sample makes the assumption that calls from mobiles to landlines within the mobile user's country are in nationally qualified form with national calling number prefix, and that mobile MSISDN are non-geographic.

```
Notation:
CCx indicates country code of DNx.
NDCx indicates national destination code of DNx.
SNx indicates subscriber number of DNx.
NDCx_SNx indicates unparsed concatenation of NDCx and SNx.
CCx_NDCx_SNx indicates unparsed concatenation of CCx and NDCx and SNx.
NXXx indicates central office / exchange for a North American DNx
intl_prefix(CCx) indicates the international prefix in use inside CCx
natl_prefix(CCx) indicates the national prefix in use inside CCx
Given:
Caller's DN as DNa, already in normalized form
Called or Added or Imported DN as DNb, in non-normalized form, as dialed in EQO
caller's dialing area
Algorithm pseudocode:
Parse DNa, determining CCa and NDCa_SNa.
if (CCa == 1) // ie: CCa indicates North American Numbering Plan
{
    Parse NDCa_SNa, into NDCa and SNa.
}
Remove “(”, “)”, “ ”, “-”, “.” from DNb.
    - or expressed alternately, remove all except [0-9][+,pw]
// Optionally remove postfix dial codes from DNb:
Remove “,” , “w” , “p”, and any following digits following and of these characters
from DNb
// Trunk prefix handling for DNb
//Search for “+” prefix:
if “+” present in DNb
{
        Remove “+” from DNb
        Set DNb_intlprefix = true
        Set DNb_natlprefix = false
        goto DONE_PREFIX_CHECK;
}
// Search for international trunk prefix:
lookup intl prefix(CCa)
if intl_prefix(CCa) is present in DNb
{
    Remove intl prefix(CCa) from DNb
    Set DNb_intlprefix = true
}
else
{
    Set DNb_intlprefix = false
}
// Search for national trunk prefix:
lookup natl prefix(CCa)
if (natl_prefix(CCa) is not empty AND natl_prefix(CCa) is present in DNb)
{
    Remove natl prefix(CCa) from DNb
    Set DNb_natlprefix = true
}
else
{
    Set DNb_natlprefix = false
}
DONE_PREFIX_CHECK: // label for goto
// (CCa == 1) EQO caller's dialing area in NANP - Apply rules as follows
//
if (CCa == 1)
{
    if (DNb_intlprefix == true) // DNb is international number
    {
        if (length(DNb) > 15)
        {
            // Should not happen in E.164
            // Could not normalize - FINISHED
        }
        DNb = “+” + DNb; // normalized - OK
    }
    if (DNb_natlprefix == true AND DNb_intlprefix == false)
    {
        // Should not happen in NANP
        // Could not normalize - FINISHED
    }
if (DNb_natlprefix == false AND DNb_intlprefix == false)
    {
        if (length(DNb) == 7) // if form is NXXXXXX
        {
            Parse DNb, determining NXXb and XXXXb.
            // Check for valid NXXb of form [2-9][0-9][0-9]
            if (NXXb is not of form [2-9][0-9][0-9]
            {
                // Should not happen in NANP
                // Could not normalize - FINISHED
            }
            DNb = “+” + CCa + NDCa + NXXb + XXXXb;
          // normalized - FINISHED
        }
        else if (length(DNb) == 10) // if form is NPANXXXXXX
        {
            Parse DNb, determining NPAb and NXXb and XXXXb.
            // Check for valid NPAb of form [2-9][0-8][0-9]
            if (NPAb is not of form [2-9][0-8][0-9]
            {
                // Should not happen in NANP
                // Could not normalize - FINISHED
            }
            // Check for valid NXXb of form [2-9][0-9][0-9]
            if (NXXb is not of form [2-9][0-9][0-9]
            {
                // Should not happen in NANP
                // Could not normalize - FINISHED
            }
            DNb = “+” + CCa + NPAb + NXXb + XXXXb; // normalized - FINISHED
        }
        else if (length(DNb) == 11) // if form is 1NPANXXXXXX
        {
            DNb = “+” + DNb; // normalized - FINISHED
        }
        else
        {
            // Should not happen in E.164
            // Could not normalize - FINISHED
        }
    }
}
// (CCa != 1) EQO caller's dialing area in Rest of World (non-NANP) - Apply rules as
follows
//
if (CCa != 1)
{
    if (DNb_intlprefix == true) // DNb is international number
    {
        if (length(DNb) > 15)
        {
            // Should not happen in E.164
            // Could not normalize - FINISHED
        }
        DNb = “+” + DNb; // normalized - FINISHED
    }
    if (DNb_natlprefix == true AND DNb_intlprefix == false) // DNb is national number
    {
        NDCb_SNb = DNb
        if (length(CCa) + length(NDCb_SNb > 15)
        {
            // Should not happen in E.164
            // Could not normalize - FINISHED
        }
        DNb = “+” + CCa + NDCb_SNb; // normalized
    }
    if (DNb_natlprefix == false AND DNb_intlprefix == false)
    {
        // Should not happen in Europe
        // Could not normalize - FINISHED
    }
}
```

### Goals for Number Normalization

The number normalization, as in the algorithm presented, preferably accomplishes the following transformations of digits dialed in a particular country:

| | |
|---|---|
| DNb pre-import | DNb internationalized as: |

EQO User's Calling Area in North American Numbering Plan:

| | |
|---|---|
| [SNb] | +1[NDCa][SNb] |
| [NDCb][SNb] | +1[NDCb][SNb] |
| 1[NDCb][SNb] | +1[NDCb][SNb] |
| [Intl_prefix(DNa)][CCb][NDCb][SNb] | +[CCb][NDCb][SNb] |
| +[CCb][NDCb][SNb] | +[CCb][NDCb][SNb] |

EQO User's Calling Area in Rest of World:

| | |
|---|---|
| [Natl_prefix(DNa)][NDCb][SNb] | +[CCa][NDCb][SNb] |
| [Intl_prefix(DNa)][CCb][NDCb][SNb] | +[CCb][NDCb][SNb] |
| +[CCb][NDCb][SNb] | +[CCb][NDCb][SNb] |

In order to fully normalize the calling digits from the mobile client 1, the service gateway 6 performs the following set of steps to determine the country code of the telephone digits. Given a phone number DNx with any and all of “+” or international prefix or national prefix removed, the service gateway 6 can determine the country dialing code CCx using the following algorithm:

```
1. Scan list of 1 digit country codes. If a match is found,
  this is the country code. Goto 5.
2. Scan list of 2 digit country codes. If a match is found, this is the
  country code. Goto 5.
3. Scan list of 3 digit country codes. If a match is found, this is the country
  code. Goto 5.
4. If no match found by previous step, then number is invalid.
5. DONE
```

To normalize the calling digits from the interconnect provider 10 to the border proxy 7 in the system, the border proxy 7 in at least one embodiment executes the following steps:

```
Look up normalization pattern regex by source IXC
Run regex pattern on To DN
Run regex pattern on From DN
Regex pattern definition:
  Perl compatible regular expression pattern
    and
  Replacement string with match references
eg: remove prefixed 0 if present from NANP number
match pattern: (0+)(\d{3})(\d{7})
replace pattern: +$2$3
```

To de-normalize the calling digits provided by the mobile client 1 to initiate calls, such as through a J2ME platform request to the device terminal 2, in one embodiment, the mobile client 1 performs following set of steps:

```
1. For calls to an EQO network inbound DID, replace “+” with the
  national prefix of the EQO user's dialing area
2. For calls to local dialing area DN, replace “+” with national
  prefix of the EQO user's dialing area
```

To de-normalize the calling digits provided by the border proxy 7 to the termination interconnect provider 9 to complete the terminations of voice calls to the callee destination in the PSTN 5, in one embodiment, the border proxy 7 executes the following set of steps:

```
Look up de-normalization pattern regex by source IXC
Run regex pattern on To DN
Examples:
Canada
      CC: 1
    NDC size: 3 digits
    SN size: 7 digits
    National prefix: none
    Intl prefix: 011
France
    CC: 33
    NDC size: 0 digits
    SN size: 9 digits
    National prefix: 0
    Intl prefix: 00
Germany
    CC: 49
    NDC size: 2-5 digits
    SN size: 3-9 digits
    National prefix: 0
    Intl prefix: 00
Italy
    CC: 39
    NDC size: 1-3 digits
    SN size: 5-8 digits (transitioning to fixed 9 digit plan)
    National prefix: none
    Intl prefix: 00
```

The Mobile Service Application

The Mobile Service Application may be implemented in certain embodiments according to the disclosure provided in U.S. patent application Ser. No. 11/314,971 titled “Distributed System For Clustering Communications Devices And Services Available To A User” filed on Dec. 20, 2005, U.S. patent application Ser. No. 11/314,745 titled “Distributed System For Sharing Of Communication Service Resources Between Devices And Users” filed on Dec. 20, 2005, and U.S. patent application Ser. No. 11/428,283 titled “Dynamic And Context Driven Call Control And Service Bridging” filed on Jun. 30, 2006, which are hereby incorporated in by reference in their entireties.

### CONCLUSION

The various features described above may be implemented in, and fully automated by code modules executed by general-purpose computing devices, including but not limited to PCs, Personal Digital Assistants, and mobile phones. The code modules may be stored in any type or types of computer storage device or memory. It should be understood that the various steps may alternatively be implemented in-whole or in-part within specially designed hardware. Various processing steps and functions described herein may be implemented in modules other than those specifically discussed. For example, a mobile phone or other terminal device may perform some processing described as occurring at the service gateway. It will be understood that the processing power of various components, system configurations, or access to various resources may provide incentives to distribute processing tasks among components differently than described herein.

Although this invention has been described in terms of certain embodiments and applications, other embodiments and applications that are apparent to those of ordinary skill in the art, including embodiments which do not provide all of the features and advantages set forth herein, are also within the scope of this invention. Accordingly, the scope of the present invention is intended to be defined only by reference to the following claims.

What is claimed is:

1. A system for call routing, the system comprising:
a service gateway; and
an application client adapted to run on a call initiating device having an associated telephone number and an address book;
wherein the service gateway includes a module that accepts an input telephone number, amends the input telephone number into a format used by the system based on the call initiating device's associated telephone number, and updates an entry in the call initiating device's address book with the newly formatted input telephone number for use by the system.

2. The system of claim 1, wherein the call initiating device is a mobile device.

3. The system of claim 1, wherein the application client is further capable of communicating with the service gateway through a signaling interface.

4. The system of claim 1, wherein the input telephone number comprises any variant of the input telephone number with a different digit prefix that the call initiating device can use to dial to connect through a host service provider telephone network associated with the call initiating device to a callee associated with the input telephone number.

5. The system of claim 1, further comprising a border proxy adapted to interface with at least one voice origination provider service and at least one voice termination provider service that may use the newly formatted telephone number to connect the call initiating device to a callee associated with the input telephone number.

6. The system of claim 5 wherein the border proxy is adapted to interface with at least one IP voice service.

7. The system of claim 5, wherein a caller ID of the call initiating device's telephone number presented to the border proxy may be in any variant telephone digit prefix that is routable from the caller to the call origination provider network.

8. The system of claim 1, wherein the service gateway amending the telephone number is based on a home local dial access telephone number digit dial pattern prefix associated with the calling device.

9. The system of claim 1, wherein the service gateway amending the telephone number includes removing non-routable telephone number characters.

10. The system of claim 1, wherein the service gateway amending the telephone number includes determining a national trunk prefix for the telephone number.

11. The system of claim 1, wherein the service gateway amending the telephone number includes determining an alternate service network dialing prefix contained in the telephone number.

12. The system of claim 1, wherein the service gateway amending the telephone number includes checking the amended telephone number against a number of allowable digits based on an international prefix and a national prefix of the telephone number.

13. The system of claim 1, wherein the service gateway amending the telephone number puts the telephone number in E.164 format.

14. A system for call routing through at least one of a plurality of networks, the system comprising:
an application client module adapted to run on a call initiating device;
a service gateway adapted to facilitate routing of a call from the call initiating device to a call destination through at least one of a plurality of networks; and
a border proxy adapted to interface with at least one voice origination provider service and at least one voice termination provider service;
wherein the application client module is adapted to retrieve a telephone number in system format stored in memory, process the telephone number with the aid of the service gateway to convert the telephone number into a format that can be used to successfully route calls through at least one of the plurality of networks, and initiate a call from the call initiating device.

15. The system of claim 14 wherein the system format is E.164.

16. The system of claim 14 wherein the application client module initiates the call through a public switched telephone network.

17. The system of claim 14 wherein the service gateway utilizes the border proxy to bridge the call from the call initiating device through a voice-over-IP network.

18. The system of claim 14, wherein the call initiating device is a mobile phone.

19. The system of claim 14, wherein the telephone number may represent a PSTN number, an IP voice service end point, a conference bridge service resource, or a voice mail service number.

20. The system of claim 14, wherein the application client processing of the telephone number factors in a home local calling service area associated with the call initiating device.

21. The system of claim 14, wherein the application client processing of the telephone number factors in an optimal access route from the call initiating device to a callee associated with the telephone number.

22. The system of claim 14, wherein the processing of the telephone number considers the digit format required by a terminating service provider and the initiating of the call communicates the processed telephone number to the border proxy.

23. The method of claim 14, wherein processing of the telephone number considers an international prefix and a national trunk prefix of the telephone number.

24. A method of normalizing a telephone number for use in a communications system adapted to determining optimal call routing through at least one of plurality of network options, the method comprising:
loading a calling device mobile number as a reference number;
obtaining a telephone number; and
altering the telephone number into a suitable format relative to the reference number.

25. The method of claim 24, wherein the step of obtaining a telephone number includes importing the number from a contact list.

26. The method of claim 24, wherein the step of obtaining a telephone number includes accepting user entry from an application client module.

27. The method of claim 24, wherein the step of obtaining a telephone number includes accepting a user entry from a contact list provisioning web interface on a user device.

28. The method of claim 24, wherein the steps are performed on a mobile device.

29. The method of claim 24, wherein the steps are implemented by a computer system.

30. A computer system programmed to perform the method of claim 24.

31. The computer system of claim 30 wherein the computer system comprises a mobile device.
